(19) United States
(12) Patent Application Publication
(10) Pub. No.: US 2003/0032404 A1
(43) Pub. Date: Feb. 13, 2003

(54) Service zone management system & method

(76) Inventors: Garrick T. Wager, Arvada, CA (US); James A. Esson, Boulder, CO (US)

Correspondence Address: MARSH FISCHMANN & BREYFOGLE LLP/OPENWAVE SYSTEM, INC., 3151 SOUTH VAUGHN WAY, SUITE 411, AURORA, CO, 80014, US

(21) Appl. No.: 09/923,486

(22) Filed: Aug. 7, 2001

(51) Int. Cl. H04M 11/00

(52) U.S. Cl. 455/406; 455/405; 455/408

(57) ABSTRACT

A system and various methods for provisioning service zones is disclosed. Service zones establish a billing or usage rate for a particular mobile or cellular number. Multiple service zones may be utilized in relation to any one mobile number. One aspect relates to allowing the service subscriber to enter service zone information. Another aspect relates to electronically displaying service zone information to the service provider and/or the subscriber, such as by storing service zone information on a server which may be accessed over the Internet by an appropriate computer. Yet another aspect relates to displaying physical location information of a mobile communications unit at the time of a particular call, and presenting this physical location information on an electronic geographical map which also preferably depicts related service zone information.

### FIELD OF THE INVENTION

The present invention generally relates to the field of location sensitive billing for mobile communications services and, more particularly, to the management of rate or service zones for mobile communications services.

### BACKGROUND OF THE INVENTION

Location sensitive billing has been proposed for mobile communications services. This generally entails establishing a number of rate or service zones and assigning a corresponding billing or usage rate for use of a mobile communications device within each particular zone. Typical usage rate zones would include a “home” zone and a “work” or “office” zone. Different usage rates would typically apply to each of these different service zones. Billing for use of a given mobile communication device in a location based billing system entails somehow identifying the physical location of the mobile communications device when making a call, comparing this physical location with the service zone(s) associated with the mobile communications device, and accumulating charges for the call based upon the usage rate associated with the service zone in which the mobile communications device was located when making the call in question. Usage rate information may be provided to the user of the mobile communications device, preferably before charges begin accruing for the subject call so as to apprise the user of the mobile communications device of potentially high or premium usage rates.

A number of methods have been proposed for assigning the above-noted types of service zones for location sensitive billing applications. One proposed approach is simply to have an account holder contact a customer care or service representative of the subject mobile communications service and provide an address which the customer care representative inputs to have a service zone defined therefrom. Another proposed approach is to allow a user of the mobile communications device to establish the desired zone by sending an appropriate signal from the mobile communications device when the mobile communications device is in a desired physical location, which is then used to establish a certain service zone. In any case, information on the various usage rates will typically be provided on the monthly bill.

Notwithstanding the advancements which have been made in relation to location sensitive billing for mobile communications services, there remains a need for more effective management of such location sensitive billing services, particularly in relation to/by the mobile communications service subscribers.

### BRIEF SUMMARY OF THE INVENTION

A first aspect of the present invention is generally related to the management of zones of any type. More specifically, the first aspect is embodied in a system/method in which a first physical location is identified, and this in turn is utilized to establish a first zone. Any way of defining the first zone, based upon an identified physical location, may be utilized in relation to the subject first aspect. This first zone is then displayed on a first map of a first geographical area in electronic form, such as on a monitor of a computer or a computer system.

One application of the first aspect of the present invention is to manage service zones in location sensitive billing applications for mobile communications services. In this case, the first aspect of the present invention could be embodied in a system/method for providing service zone information for a first mobile communications service. This first aspect will be described with regard to a first mobile communications number that utilizes this first mobile communications service. This “mobile communications number” may be any appropriate identifier, including the number which is dialed to access a first mobile communications unit or device which is assigned the mobile communications number or an associated account number. It should also be appreciated that in most instances a provider of the first mobile communications service (hereafter a “first service provider”) that utilizes this particular application of the subject first aspect of the present invention will typically have multiple service subscribers, and thereby multiple mobile communications numbers. The subject first aspect of the present invention may be utilized in relation to any one or more of these multiple mobile communications numbers. Moreover, the subject first aspect may also be implemented for multiple service providers.

The location sensitive billing application of the subject first aspect involves identifying a first physical location, which in turn is utilized to establish a first service zone. All communications involving the first mobile communications number from within the first service zone are billed at a first rate (e.g., made from a first mobile communications unit when physically located within this first service zone at least at some point in time during the subject call or communication). Any way of defining the first service zone, based upon an identified physical location, may be utilized in relation to the subject first aspect. This first service zone is displayed on a first map of a first geographical area in electronic form, such as on a monitor of a computer or a computer system.

Various refinements exist of the features noted in relation to the subject first aspect of the present invention. Further features may also be incorporated in the subject first aspect of the present invention as well. These refinements and additional features may exist individually or in any combination. These refinements and additional features will be discussed in relation to the above-noted location sensitive billing application for mobile communications services, but are applicable/extendable to any appropriate application which requires the management of one or more zones. One way in which the first physical location may be identified is by some way entering data which describes or otherwise defines a first address which corresponds with and/or which at least may be utilized to define the first physical location (e.g., using a keyboard on a computer/computer system). Specific addresses may be entered to define the first physical location (e.g., 367 Cherry Street, Hometown, Colo. XXXXX). Another option would be to enter data which describes or otherwise defines a more general location, such as a particular country, state, town, city, county, township, district, subdivision, neighborhood, or any other “predefined area” (e.g., a particular park). Entry of this more general physical location information may then affect the electronic display of this more general physical location on an appropriate display device (e.g., computer monitor) to allow for the “selection” of a more specific physical location therefrom (e.g., by selecting from a list of choices display on the electronic display or pointing to a more specific area on the electronic map and somehow “selecting” the same, for instance by a mouse “click”) for purposes of defining a service zone therefrom. Alternatively, the “entry” of a general physical location may itself define the first service zone such that the general physical location and the first service zone are coterminous or one in the same. In any case, the entry of data which defines the first physical location thereafter may be geo-coded (e.g., converted into a single latitude, longitude coordinate) for storage in an appropriate database that is electronically stored on an appropriate computer/computer system.

The first physical location upon which the first service zone is based may also be identified by displaying an electronic second map of a second geographical area on an appropriate display. A first data entry device of a first computer system on which the first map is being electronically displayed may then be utilized to “select” the first physical location. For instance, a mouse may be utilized to move a cursor to the desired location on the second electronic map, and to thereafter “click” on this particular desired location for purposes of establishing the first physical location. GIS software applications may be implemented to affect this type of data entry protocol. Other types of data entry devices could be utilized as well for purposes of making this “selection” on the electronic second map, such as “touch screens,” and the like.

Any number of “parties” may provide the first physical location information upon which the first service zone is to be based. The subscriber which has been assigned the first mobile communications number by the first service provider may provide the first physical location information. Personnel that are somehow associated with the first service provider may also identify the first physical location. Oftentimes this will be a customer care representative or the like that is employed by the first service provider. Third-party services may also be engaged by the first service provider to manage one or more aspects of their communications services, such that the personnel which “identify” the first physical location in accordance with the subject first aspect need not necessarily be directly employed by the first service provider.

One way in which the subject first aspect may be implemented to allow the subscriber which has been assigned the first communications number, the first service provider or a third party acting on behalf of the first service provider, or “both,” to identify the first physical location upon which the first service zone is to be based, is through a service zone management system of sorts which includes a first server and on which appropriate content and/or protocol resides (or is at least accessible through such a first server). For instance, the first server may include a computer-readable storage medium or computer-readable storage medium system on which one or more databases are stored. Relevant information on all of the mobile communications numbers which have been issued/assigned by the first service provider, and which are utilizing the subject first aspect of the present invention, may be stored on this computer-readable storage medium system. All relevant service zone information relating to each of these mobile communications numbers also may be stored on this computer-readable storage medium/system, as well as one or more electronic maps of one or more geographical areas or data which is used to define these maps. Preferably, there is an electronic map of each geographical area which has at least one service zone located therewithin or data for generating such a map. Although the computer-readable storage medium system associated with the first server is preferably local in relation to the first server, such need not be the case. That is, information regarding the first mobile communications number, the map(s) of the relevant geographical area(s) or the data to generate any such map(s), or both, may be stored remotely in relation to the first server.

Communication may be established between the above-noted first server and a first computer (which may include any “remote” data entry device such as a wireless handheld unit). Appropriate ways of establishing communication between the first server and the first computer include having the first server and first computer be operatively interconnected or at least operatively interconnectable through an appropriate communications network such as the Internet. Other appropriate communication networks or ways of providing for this operative interface include using wireless communication technologies, in which case the noted “first computer” could be a wireless handheld device such as a cell phone. Any appropriate way of establishing communication may be utilized for providing communication between the noted first server and first computer in relation to the first aspect.

It should be appreciated that the above-referenced “first computer” contemplates that the “first computer” may be associated with the subscriber which has been assigned the first mobile communications number by the first service provider, that the “first computer” may be associated with the first service provider or a third party acting on behalf of the service provider, and that multiple first computers may be utilized. Each service subscriber having a mobile communications number for the first mobile communications service and for which service zone information provisioning has been/is being provided in accordance with the subject first aspect preferably has access to the first server through their own “first computer” as well, as does the first service provider or a third party acting on behalf of the first service provider.

The electronic first map associated with the first aspect may display information regarding the first service zone in any appropriate manner. For instance, the border of the first service zone may be outlined on the first electronic map to differentiate the same from surrounding areas. Color variations may be utilized on the first electronic map to differentiate the first service zone from surrounding areas on the electronic first map as well. “Shading” techniques (e.g., gray scale) may also be utilized to differentiate the first service zone from surrounding areas on the electronic first map. Information other than merely the location of the first service zone relative to the first geographical area encompassed by the electronic first map may be displayed on the first map as well. Streets, highways, landmarks, and the like (e.g., lakes, parks, historical sites) may be displayed on the electronic first map to provide more context of sorts to the actual physical location of the first service zone. Multiple service zones for the subject first mobile communications number may be established in the same manner as the first service zone, and simultaneously electronically displayed therewith on the same electronic map in accordance with the subject first aspect as well. However, in some instances a map which electronically displays multiple service zones in accordance with the subject first aspect may be of a larger geographical area than an electronic map which displays fewer service zones. Less detail may be provided on electronic maps which display a larger number of service zones over a larger geographical area. Nonetheless, the first aspect of the present invention also contemplates providing the same level of detail on each electronic map which displays any service zone.

A second aspect of the present invention relates to a system/method for providing service zone information on a first mobile communications service. This second aspect will be described with regard to a first mobile communications number similar to that discussed above in relation to the first aspect of the present invention. It should also be appreciated that in most instances a provider of the first mobile communications service (again hereafter a “first service provider”) that utilizes the subject second aspect of the present invention will typically have multiple service subscribers and thereby multiple mobile communications numbers. The subject second aspect of the present invention may be utilized in relation to any one or more of these multiple mobile communications numbers.

The subject second aspect of the present invention generally involves electronically displaying the physical location of a first mobile communications unit when the same was used for a particular call or communication, and providing this electronic display in “overlying relation” of sorts to one or more similarly electronically displayed service zones on a map of a geographical area. All communications by the first mobile communications device within a given service zone are billed at a predetermined rate. Typically at least some of these service zones will be associated with different billing or usage rates.

The subject second aspect includes electronically displaying a first service zone on a first map of a first geographical area. All communications which involve the first mobile communications number from within the first service zone are billed at a first-rate. Consider the case where a first mobile telecommunications device, which has been assigned the first mobile communications number, has been used for a first communication, and that at least at some point time during this first communication the first mobile communications unit was at a first physical location. The subject second aspect includes electronically displaying this first physical location on the electronically displayed first map along with the first service zone.

Various refinements exist of the features noted in relation to the subject second aspect of the present invention. Further features may also be incorporated in the subject second aspect of the present invention as well. These refinements and additional features may exist individually or in any combination. The electronic display of the first service zone on the first map of the first geographical area, as well as the electronic display of the first physical location of the first mobile communications unit on the first map of the first geographical area at the time of making the first communication, may be affected on a display device being utilized by a subscriber which has been assigned the first mobile communications number, by the first service provider or third party acting on behalf of the first service provider, or both. The first physical location of the first mobile communications unit, as determined by the location sensitive billing application (e.g., via a mobile switching center, via any other type location finding or position determination equipment) when making the first communication, may encompass a geographical area which is smaller than the first service zone, but which is larger than a single longitude/latitude coordinate. This accounts for the fact that there may be a certain degree of uncertainty as to the exact location of the first mobile communications unit at the subject time during the first communication (e.g., depending upon the technology and/or physical equipment which was utilized to determine the location of the first mobile communications unit at the relevant time).

The electronic first map associated with the subject second aspect may display information regarding the first service zone in any appropriate manner. For instance, the border of the first service zone may be outlined on the first electronic map to differentiate the same from surrounding areas. Color variations may be utilized on the first electronic map to differentiate the first service zone from surrounding areas on the electronic first map. “Shading” techniques (e.g., gray scale) may also be utilized to differentiate the first service zone from surrounding areas on the electronic first map. Information other than merely the location of the first service zone relative to the first geographical area encompassed by the electronic first map may be displayed on the first map as well. Streets, highways, landmarks, and the like (e.g., lakes, parks, historical sites) may be displayed on the electronic first map to provide more context of sorts to actual physical location of the first service zone. Multiple service zones may be established in the same manner as the first service zone, and simultaneously electronically displayed therewith on the same electronic map in accordance with the subject second aspect as well. In some instances a map which electronically displays multiple service zones in accordance with the subject second aspect may be of a larger geographical area than an electronic map which displays fewer service zones. Less detail may be provided on electronic maps which display larger number of service zones. However, the second aspect of the present invention also contemplates providing the same level of detail on each electronic map which displays any service zone.

A second geographical area which includes a plurality of service zones associated with the first mobile communications number may be electronically displayed on a second map in response to the entry of relevant information and which may also include the first service zone. This electronic second map may be configured so as to initially display service zone information regarding the first mobile communications number, but not information regarding the physical location of the first mobile telecommunications device from previous communications involving the same. Communications involving the first mobile communications number may be “selected” for display on the electronic second map of the second geographical area by entering one or more “search terms” of sorts. Those communications involving the first mobile communications number which satisfy the “search criteria” may then be displayed on the electronic second map. Another option would be to display physical location information regarding the first mobile telecommunications number at the time of communications involving the same only upon selection of one of the plurality of service zones being displayed on the electronic second map. However, the electronic second map may also be implemented in a manner such that at least some and possibly all physical location information regarding the first mobile communications unit will be displayed on the electronic second map.

A list of communications involving the first mobile communications number may be displayed further in relation to the subject second aspect of the present invention. Various types of information relating to each of these communications may be included in the listing as well (e.g., start/end time of the subject communication). Selection of one or more of these communications may affect the display of one or more of the service zones associated with the first mobile communications number, as well as the actual physical location of the first mobile communications unit at least at some point in time during the execution of the selected communication.

One way in which the subject second aspect may be implemented to allow a subscriber of the first communications service which has been assigned the first mobile communications number, the first service provider or a third party acting on behalf of the first service provider, or “both,” to review physical location information regarding the first mobile communications number in relation to one or more service zones associated with the first mobile communications number, is through a service zone management system of sorts which includes a first server and on which appropriate content and/or protocol resides. For instance, the first server may include a computer-readable storage medium or computer-readable storage medium system on which one or more databases are stored. Relevant information on all of the mobile communications numbers which have been assigned or issued by the first service provider, and which are utilizing the subject second aspect of the present invention, may be stored on this computer-readable storage medium. All service zone information for each of these mobile communications numbers may also be stored on this computer-readable storage medium system, as well as one or more electronic maps of geographical areas which encompass each of the service zones or at least data for generating the same. Although the computer-readable storage medium system is preferably local in relation to the first server, such need not be the case. That is, the first mobile communications number and related service zone information, the electronic map(s) or the data to generate the same, or both may be stored remotely in relation to the first server as well.

Communication may be established between the above-noted first server and a first computer (which may include any “remote” data entry device such as a wireless handheld unit). Appropriate ways of establishing communication between the first server and the first computer include having the first server and first computer be operatively interconnected or at least operatively interconnectable through an appropriate communications network such as the Internet. Other appropriate communication networks or ways of providing for this operative interface include using wireless communication technologies, in which case the noted “first computer” could be a wireless handheld device such as a cell phone. Any appropriate way of establishing communication may be utilized for providing communication between the noted first server and first computer in relation to the second aspect.

It should be appreciated that the above-referenced “first computer” contemplates that the “first computer” may be associated with the service subscriber which has been assigned the first mobile communications number by the first service provider, that the “first computer” may be associated with the first service provider or a third party acting on behalf of the service provider, and that multiple of first computers” may be utilized. Each service subscriber having a mobile communications number for which service zone information provisioning is being provided in accordance with the subject second aspect preferably has access to the first server through their own “first computer”, as does the first service provider or a third party acting on behalf of the first service provider.

### BRIEF DESCRIPTION OF THE SEVERAL VIEWS OF THE DRAWING

FIG. 1 is schematic of one embodiment of a mobile communications system.

FIG. 2 is a schematic of one embodiment of the service zone provisioning system used by the mobile communications system of FIG. 1.

FIG. 3 is a schematic of one embodiment of a computer which may be utilized by any of the service provider computers and/or service subscriber computers of the service zone provisioning system of FIG. 2.

FIG. 4 is one embodiment of the service zone provisioning server of the service zone provisioning system of FIG. 2.

FIG. 5 is one embodiment of a service subscriber database system of the service zone provisioning server of FIG. 4.

FIG. 6 is one embodiment of a logged calls database system of the service zone provisioning server of FIG. 4.

FIG. 7 is one embodiment of a service zone management protocol for a service zone management module of the service zone provisioning server of FIG. 4.

FIG. 8 is one embodiment of a display protocol for a display module of the service zone provisioning server of FIG. 4.

FIG. 9 is one embodiment of a find/create subscriber screen which may be utilized by the service zone provisioning server of FIG. 4.

FIG. 10 is one embodiment of a login screen which may be utilized by the service zone provisioning server of FIG. 4.

FIG. 11 is one embodiment of a service zone generation screen which may be utilized by the service zone provisioning server of FIG. 4.

FIG. 12 is one embodiment of a map/rate zone/call log screen which may be utilized by the service zone provisioning server of FIG. 4.

FIG. 13 is one embodiment of a call log screen which may be utilized by the service zone provisioning server of FIG. 4.

FIG. 14 is one embodiment of a service zone/call display screen which may be utilized by the service zone provisioning server of FIG. 4.

FIG. 15 is one embodiment of a subscriber settings screen which may be utilized by the service zone provisioning server of FIG. 4.

### DETAILED DESCRIPTION OF THE INVENTION

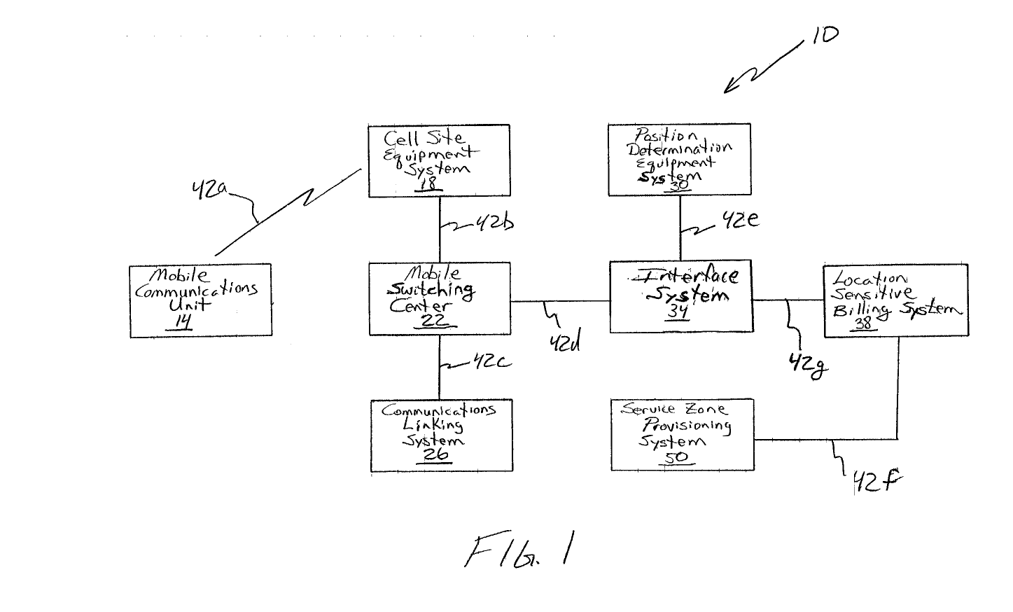

The present invention will now be described in relation to the accompanying drawings which at least assist in illustrating its various pertinent features. One embodiment of a mobile communications system 10 is presented in FIG. 1. The mobile communications system 10 includes at least one mobile communications unit 14 (e.g., a cellular phone) which communicates with a cell site equipment system 18 by an appropriate communications link 42a. The cell site equipment system 18 may include one or more cell sites (not shown), with each cell site having one or more antennas (not shown). An appropriate communications link 42b operatively interconnects the cell site equipment system 18 with a mobile switching center 22. The mobile switching center 22 in turn is operatively interconnected with a communications linking system 26 (e.g., a telephone company central office, one or more central switching offices) by an appropriate communications link 42c. Communications involving the mobile communications unit 14 are thereby directed through the cell site equipment system 18, the mobile switching center 22, and communications linking system 26 to the other device(s) involved in the subject communication. Any way of providing communication capabilities between a given mobile communications unit 14 and another communication device may be employed in relation to the communications system 10.

An interface system 34 (e.g., a platform) is part of or operatively interconnected with the mobile switching center 22 by an appropriate communications link 42d. Multiple components may interface with (via another appropriate platform) or be part the this interface system 34 in relation to communications involving any mobile communications unit 14 of the mobile communications system 10 (e.g., communications being directed through the mobile switching center 22). One such component is a position determination equipment system 30 which is operatively interconnected with the interface system 34 in the illustrated embodiment by an appropriate communications link 42e. The position determination equipment system 30 generally functions to determine the location of a particular mobile communications unit 14 for one or more purposes. Location information on a particular mobile communications unit 14 may also be provided by/through the cell site equipment system 18 and/or the mobile switching center 22, such as in the form of cell or cell sector identification capabilities.

Various technologies may be employed by the position determination equipment system 30, and at one or more physical locations throughout the mobile communications 10. Typically the position determination equipment system 30 will include multiple pieces of position determination equipment which are distributed throughout the mobile communications system 10. Any technology which is appropriate for determining the location of a given mobile communications unit 14 may be employed by the position determination equipment system 30 at any of its physical sites throughout the mobile communications system 10. Representative examples of position determination technologies which are appropriate for the position determination equipment system 30 include GPS-based technologies, cell sector or micro-cell location technologies, time difference of arrival (TDOA) technologies, angle of arrival (AOA) or other network triangulation technologies, EOTD (enhanced observed time difference, TOA (time-of-arrival)—assisted GPS, and GPS.

A location sensitive billing system 18 may be part of or separate from the communications system 10, and further may be part of or operatively interconnected or at least interconnectable with the interface system 34 by an appropriate communications link 42g. Billing for communications involving any mobile communications unit 14 of the mobile communications system 10 is affected through the location sensitive billing system 38. Typically each mobile communications unit 14 will be associated with one or more predefined rate or service zones, with each such zone having a predetermined usage or billing rate associated therewith. Usage of a given mobile communications unit 14 within a given service zone, as determined by the position determination equipment system 30 or more typically the mobile switching center 22, will be billed by the location sensitive billing system 38 at the usage rate which is associated with the subject service zone for the subject mobile communications unit 14. An example of a configuration for providing a location sensitive billing function is disclosed in U.S. Pat. No. 5,774,802, which is entitled “Apparatus and Method for Billing in a Wireless Communication System, and the entire disclosure of which is incorporated by reference in its entirety herein. However, any configuration which provides location sensitive billing may be utilized by the location sensitive billing system 38 for purposes of the communications system 10.

A service zone provisioning system 50 may also be part of or separate from the mobile communications system 10, and nonetheless is operatively interconnected or at least interconnectable with the location sensitive billing system 38 by an appropriate communications link 42f. The service zone provisioning system 50 enhances one or more aspects of the location sensitive billing system 38. One function provided by the service zone provisioning system 50 is to enhance the management of the rate or service zone(s) of at least one, and more preferably each, mobile communications unit 14 of the mobile communications system 10. More accurately it is a mobile communications or cellular number which is associated with a given mobile communications unit 14 that is the basis upon with the functions associated with the service zone provisioning system 50 are provided. Service zones for a given mobile communications unit 14 may be established, edited, and/or deleted for a given mobile communications unit 14 in a desired manner by the service zone provisioning system 50. Rate or service zone information for a given mobile communications unit 14 may also be graphically displayed in association with a map of a relevant geographical area by the service zone provisioning system 50, including while executing the above-noted service zone provisioning functions. Information on one or more communications or calls involving a given mobile communications unit 14 may also be graphically displayed by the service zone provisioning system 50 in relation to one or more service zones associated with the subject mobile communications unit 14 and in overlying or superimposed relation to a map of a relevant geographical area. These and various other features of the service zone provisioning system 50 will be discussed in more detail below. Notwithstanding the presentation of the embodiment presented in FIG. 1, it should be appreciated that any configuration/arrangement in relation to the mobile communications system 10 and/or any of the other above-noted components that allows for execution of the functionality of the service zone provisioning system 50 may be utilized. Moreover, other components, systems, or the like may be required in order to allow for the appropriate data to be transmitted and/or received.

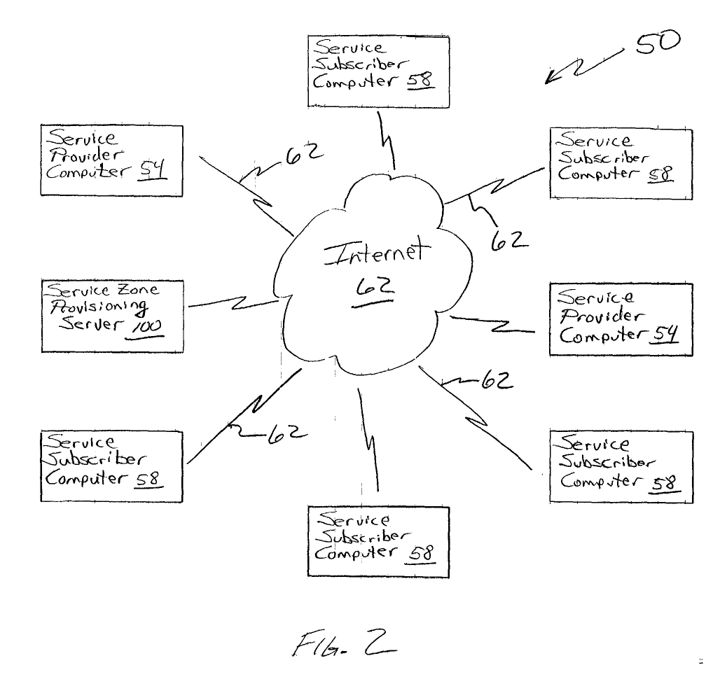

Details regarding one embodiment of the service provisioning system 50 are presented in FIG. 2. The service zone provisioning system 50 of FIG. 2 includes a service zone provisioning server 100. Access to the service zone provisioning server may be realized by any appropriate communications link, but is preferably established over the Internet 62. Multiple parties of sorts may access the service zone provisioning server 100. Both the provider of the communications service over the mobile communications system 10 (hereafter “service provider”) and each user having a mobile communications unit 14 (hereafter “service subscriber”) for accessing this communications service each preferably have access to the service zone provisioning server 100. Although the service zone provisioning system 50 will typically be implemented as a custom installation for a given provider of communications services, and will hereafter be discussed in this manner, it should be appreciated that the service zone provisioning system 50 could also be implemented in a manner so as to simultaneously accommodate multiple service providers and their various service subscribers. In any case, the subject service provider may access the service zone provisioning server 100 at one or more different physical sites or locations through an appropriately configured service provider computer 54. The service provider may utilize employees (e.g., customer care representatives and the like) and/or one or more third parties to interface with the service zone provisioning system 50. Each service subscriber having a mobile communications unit 14 similarly has access to the service zone provisioning server 100 via an appropriately configured service subscriber computer 58. It should be appreciated that it need not necessarily be the actual service subscriber that accesses the service zone provisioning server 100, but instead may be another acting on behalf of the service subscriber (e.g., a family member).

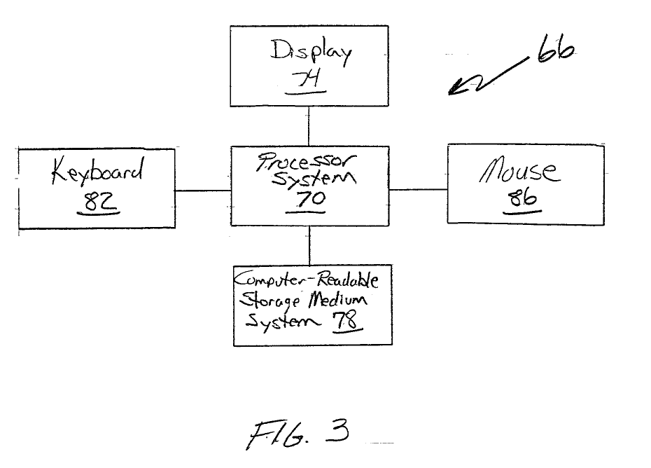

One embodiment which may be utilized for any service provider computer 54 and/or any service subscriber computer 58 utilized by the service zone provisioning system 50 of FIGS. 1-2 is presented in FIG. 3. The computer 66 of FIG. 3 generally includes a processor system 70 (e.g., at least one CPU). The computer 66 also includes a computer-readable storage medium system 78 (e.g., a hard drive, a disk drive, a CD drive), a keyboard 82, a mouse 86, and a display 74, each of which is operatively interconnected with the processor system 70. This configuration of FIG. 3 is typical to both desktop and portable/laptop computers. Other configurations may be appropriate for allowing a service provider computer 54 and/or service subscriber computer 58 to access the service zone provisioning server 100 of FIG. 2, although such will typically include at least some type display and at least one type of data entry device for purposes of the service zone provisioning system 50.

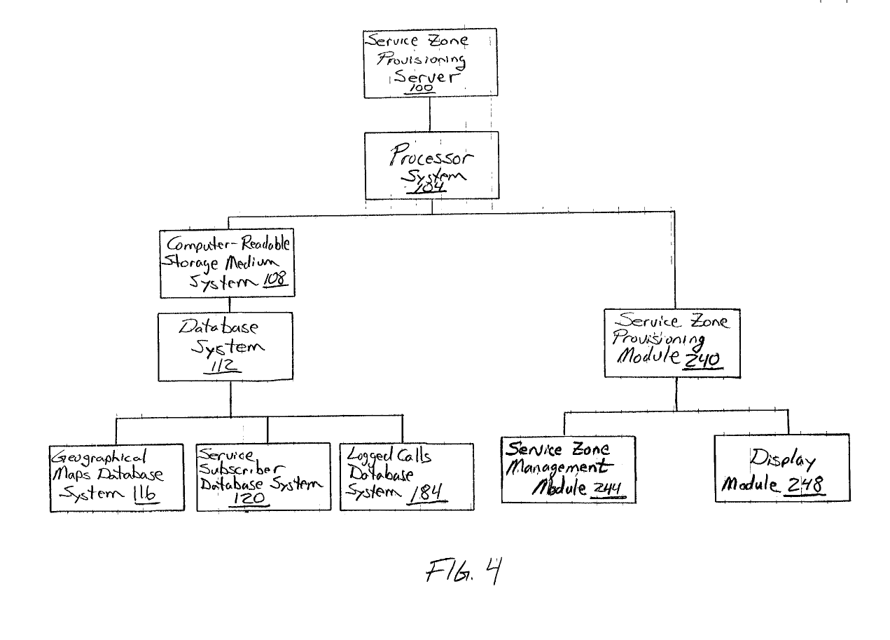

FIG. 4 presents details regarding one embodiment of the service zone provisioning server 100 of FIG. 2. Generally, the service zone provisioning server 100 includes a processor system 104 (e.g., at least one CPU). A computer-readable storage medium system 108 (e.g., one or more hard drives, one or more floppy drives, one or more CD drives) is operatively interconnected with the processor system 104. At least some of the information utilized by the service zone provisioning system 50 is stored on the computer-readable storage medium system 108 within a database system 112. “Database” in the context of the service zone provision system 50 simply means a way of storing/cataloging data or information of various types.

Multiple databases define the database system 112 of the service zone provisioning server 100. One of the databases of the database system 112 is a geographical map database system 116 which stores one or more maps, or more typically data that is used to create such maps, of geographical areas which are relevant to the service zone provisioning system 50 (e.g., in digital form). Each subscriber having a mobile communications unit 14 again will typically have multiple service or rate zones with different usage rates associated therewith. One or more of these service or rate zones may be electronically displayed to the service provider and/or the subject service subscriber on a similarly electronically displayed map of the geographical area which contains these service zones in a manner which will be discussed in more detail below. Therefore, preferably the geographical maps database system 116 includes one or more maps or digital images, or again data used to create such maps or digital images, of each geographical area having at least one service zone of at least one service subscriber therewithin. Although the map(s)/data used to create such map(s) of the relevant geographical area(s) is preferably stored in the geographical maps database system 116 on the service zone provisioning server 100, it may be possible for the service zone provisioning server 100 to retrieve this information from external sources, such as one or more web sites which are accessible via the Internet 62 or any other appropriate communications medium.

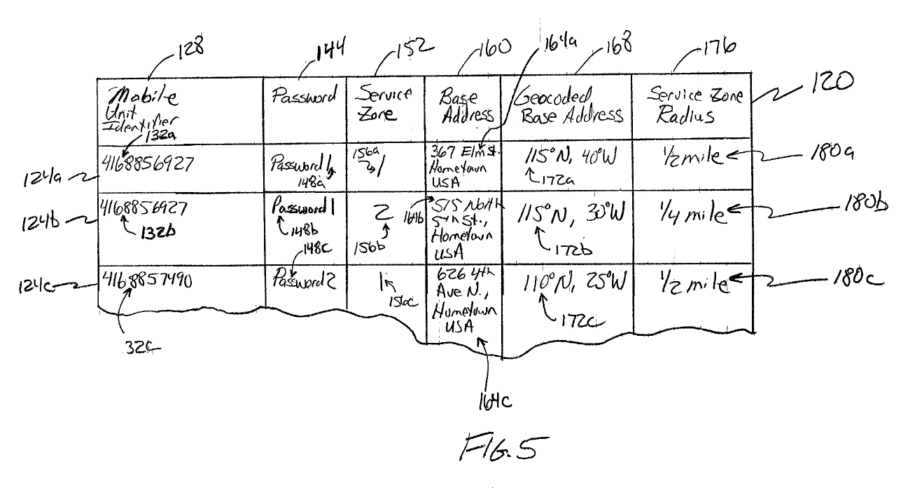

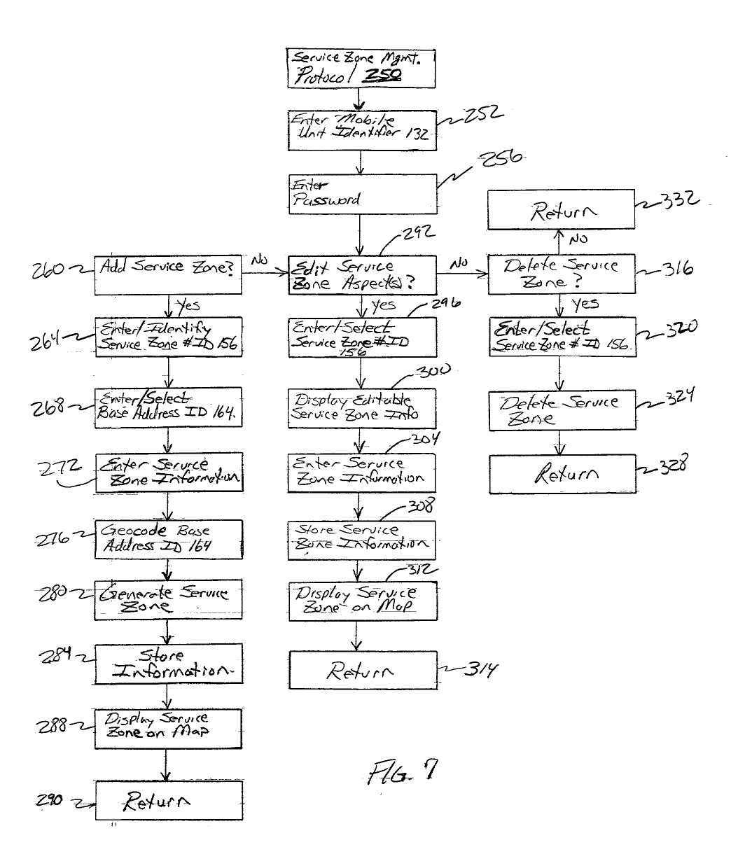

Additional information utilized by the service zone provisioning system 50 is stored within a service subscriber database system 120 of the database system 112 presented in FIG. 4. Generally, the service subscriber database system 120 stores information relating to each of the service or rate zones which are associated with each mobile communications unit 14 of the communications system 10. Details regarding one embodiment of the service subscriber database system 120 are presented in FIG. 5. The service subscriber database system 120 generally includes a database record 124 for each service or rate zone of each mobile communications unit 14 within the communications system 10. Each database record 124 preferably contains the following fields or information types and corresponding data or information: 1) a mobile communications unit number or identifier field 128 for storing a mobile communications unit number or identifier 132; 2) a password field 144 for storing a password identifier 148; 3) a rate or service zone field 152 for storing a service zone identifier 156; 4) a physical location or base address field 160 for storing a physical or base address identifier 164; 5) a geocoded physical or base address field 168 for storing a geocoded physical or base address identifier 172; and 6) a rate or service zone radius field 176 for storing a rate or service zone radius identifier 180. By way of initial introduction: 1) the mobile communications unit identifier 132 is any appropriate way of identifying a particular mobile communications unit 14, such as its cellular telephone number, although such could be any unique “code” of one or more numbers, letters, characters, or any combination thereof; 2) the password identifier 148 is any unique “code” of one or more numbers, letters, characters, or any combination thereof, and may be implemented as a security feature for the service zone provisioning system 50; 3) the service zone identifier 156 is any appropriate way of identifying a particular service zone which is associated with the subject mobile communications unit 14; 4) the physical or base address identifier 164 is any appropriate way of identifying a particular geographical location, such as a street address; 5) the geocoded physical or base address identifier 172 is the physical or base address identifier 164, expressed as a longitudinal and latitude coordinate; 6) the service zone radius identifier 180 is a measure of distance. At least some of the information which is stored on the service subscriber database system 120 may also be stored on the interface system 34 or on some other part of the mobile communications system 10, including that which is stored in the mobile communications unit number or identifier field 128, the geocoded base address field 168, and the rate or service zone radius field 176 in the database 120; and 7) the base address identifier 164 of a given database record 124 and the associated service zone radius identifier 180 are used to define the area encompassed by the service zone which corresponds with the associated service zone identifier 156. Any appropriate data storage structure/technique may be utilized for storing this type of information. How this information which is stored in the service subscriber database system 120 is utilized by the service zone provisioning system 50 is addressed in more detail below in relation to FIGS. 7-15.

Referring back to FIG. 4, the database system 112 also includes a logged calls database system 184. Each call or communication which is made by each mobile communications unit 14 of the mobile communications system 10 is “logged” or processed by the location sensitive billing system 38 of FIG. 1. Although at least some of this information may be originally stored at/on the interface system 34 of FIG. 1 or some other structure of the mobile communications system 10, once the calls are logged by the location sensitive billing system 38, information on each logged call is preferably transferred to the logged calls database system 184 of FIG. 4.

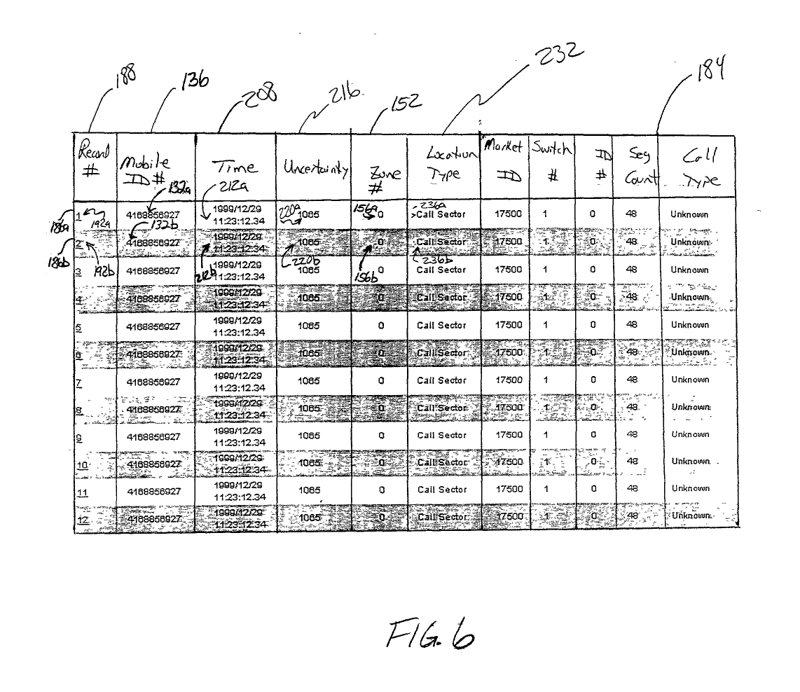

Details regarding one embodiment of the logged calls database system 184 are presented in FIG. 6. The logged calls database system 184 generally includes a database record 186 of each call or communication involving each mobile communications unit 14 of the communications system 10. Each database record 186 preferably contains at least the following fields or information types and corresponding data or information: 1) a record number field 188 for storing a record number identifier 192; 2) the above-noted mobile communications unit identifier field 136 for storing the above-noted mobile communications unit identifier 132; 3) a time field 208 for storing a time identifier 212; 4) an uncertainty field 216 for storing an uncertainty identifier 220; 5) the above-noted rate or service zone field 152 for storing the above-noted rate or service zone identifier 156; and 6) a location type field 232 for storing a location type identifier 236. Various other types of may be contained in each database record 186. By way of initial summary: 1) the mobile communications unit identifier 132 again is any appropriate way of identifying a particular mobile communications unit 14, such as its cellular telephone number, although such could be any unique “code” of one or more numbers, letters, characters, or any combination thereof; 2) the time identifier 212 is any appropriate way of identifying the time, date, and/or duration of the subject call or communication; 3) the uncertainty identifier 216 is some way of identifying an uncertainty or “confidence level” as to the physical location of the mobile communications unit 14 at some point in time during the subject call communication (typically at the start thereof, but not so limited), and as determined by the position determination equipment system 30 of FIG. 1, but more typically the mobile switching center 22; 4) the service zone identifier 156 again is any appropriate way of identifying a particular service zone which is associated with the subject call or communication by the mobile communications unit 14; and 5) the location type identifier 236 at least somehow identifies the particular type of equipment or technology which was utilized by the position determination equipment system 30 of FIG. 1 to determine the physical location of the mobile communications unit 14 at least at some point in time during the subject communication.

The service zone provisioning server 100 of FIGS. 2 and 4 not only stores various types of information which is utilized by the service zone provisioning system 50, but also provides for the execution of various functions relating to the service or rate zones which are utilized by the location sensitive billing system 38 of the communications system 10 of FIG. 1 as well. Referring back to FIG. 4, the service zone provisioning server 100 also includes a service zone provisioning module 240 which is part of and/or operatively interconnected with the processor system 104 of the service zone provisioning server 100. Two basic functions are provided by the service zone provisioning module 240. Management of the service zone(s) associated with each of the mobile communications units 14 of the communications system 10 may be affected through a service zone management module 244 of the service zone provisioning module 240. One protocol which may be employed by the service zone module 244 to provide this service zone management function is presented in FIG. 7. As noted above, the configuration of the computer 66 presented in FIG. 3 is an applicable configuration for any service provider computer 54 of the service zone provisioning system 50 or any service subscriber computer 58 of the service zone provisioning system 50. The service zone management protocol 250 FIG. 7 will be discussed in relation to using the computer 66 for accessing and interfacing with the service zone provisioning server 100.

The service zone management protocol 250 of FIG. 7 is initiated at step 252 where the mobile communications unit identifier 132 associated with the subject mobile communications unit 14 is somehow entered or otherwise selected (e.g., by using the keyboard 82, by using the mouse 86 to “click” on the associated mobile communications unit identifier 132 from listing of mobile unit identifiers 132 which may be presented on the display 74). Security measures may be incorporated in relation to the service zone provisioning system 50 for execution of the service zone management protocol 250. In this regard, the service zone management protocol 250 includes a step 256 which is directed toward prompting the user of the service zone provisioning system 50 to enter the password identifier 148 which is associated with the mobile unit identifier 132 which was provided at step 252 of the protocol 250. Typically step 256 will only be presented/executed when access to the service zone provisioning server 100 is being attempted by or on behalf a service subscriber via a service subscriber computer 58, versus by or on behalf of the service provider via a service provider computer 54 (FIG. 2). Nonetheless, the same or similar types of security measures could also be implemented when access to the service zone provisioning system 50 is being attempted by or on behalf of the service provider via a service provider computer 54.

Three basic functions are provided through the service zone management protocol 250 of FIG. 7. One of these functions is the addition of a service zone in relation to a particular mobile communications unit 14. How the selection is made to initiate this function is not of particular significance. For instance, this option could be presented to the user of the service zone provisioning system 50 on the subject display 74 of the computer 66 being used to access the service zone provisioning server 100, and could be “selected” by using the mouse 86 of the computer 66 to “click” on this option from a listing of available options. In any case, step 260 “inquiries” as to whether the desired function is to add a service zone. “Responding” in the affirmative advances the service zone management protocol 250 from step 260 to a step 264. Step 264 is directed to the provision, entry, or identification of the service zone identifier 156 which is associated with the mobile communications unit identifier 132 which was entered at step 252 of the protocol 250. This may be affected in any number of ways. One option is to have the service zone provisioning server 100 automatically generate the service zone identifier 156 for each new service zone which is added through the service zone management protocol 250. Another option would be to allow the user of the service zone provisioning system 50 to somehow enter an appropriate service zone number identifier 156 or to select a desired service zone number identifier 156 from a listing that is presented on the user's display 74.

After the service zone number identifier 156 has been provided at step 264, the service zone management protocol 250 of FIG. 7 proceeds to a step 268. Step 268 of the service zone management protocol 250 is directed to the provision, entry, or selection of the base address identifier 164 which is to be associated with the service zone that is currently being added in relation the mobile unit identifier 132 which was entered at step 252 of the protocol 250. There are number of ways in which this may be affected. One option is to provide for the entry of this information by using the keyboard 82 of the user's computer 66. In this case the user of the service zone provisioning system 50 could simply type in a specific address on which the definition of the subject service zone is to be based. This information could then be automatically geocoded by the service zone provisioning server 100 and stored in the form of the corresponding geocoded base address identifier 168. Another data entry option would be to provide for the entry of this information for the base address identifier 164 by using the mouse 86 of the computer 66, namely by “clicking” on the desired location on a geographical map which is being electronically presented on the display 74 of the user's computer 66. Conventional GIS software may be utilized by the service zone provisioning system 50 to affect data entry in this manner.

The base address identifier 164 that is provided in step 268 of the service zone management protocol 250 of FIG. 7 is used to define the location of the service zone which is being added in relation to the mobile communications unit identifier 132 which was entered at step 252 of the protocol 250. In one embodiment, the service zones utilized/generated by the service zone provisioning system 50 are of a circular configuration. In this case, the base address identifier 164 that is provided at step 268 is used as a center about which the subject service zone is defined. The radius of the service zone, represented again by the service zone radius identifier 180 in the service subscriber database system 120, will typically be controlled/established by the subject service provider, although in some cases the service subscriber may have at least some flexibility in relation to entering or otherwise selecting the radius to be associated with the subject service zone. This type of information may be provided through execution of step 272 of the service zone management protocol 250. Other information may be entered regarding the service zone through execution of step 272 as well, such as the billing or usage rate which is to be associated with the service zone that is currently being added through execution of the protocol 250. This too will typically be controlled/established by the subject service provider, although in some cases the service subscriber may have at least some flexibility in relation to entering or otherwise selecting the billing or usage rate to be associated with the subject service zone as well. Notwithstanding the description of the service zone being generated by the service zone management protocol 250 as circular, it should be appreciated that other geometric shapes may be utilized for the service zones which are associated with the service zone provisioning system 50, and which may be generated in some manner based upon the entry of the base address identifier 164 in step 268 of the protocol 250 (e.g., through an appropriate function).

Step 276 of the service zone management protocol 250 of FIG. 7 provides for execution of a geocoding function. In cases where the base address identifier 164 is entered via the keyboard 82 of the user's computer 66, step 276 will transform this information into a single longitude/latitude coordinate, and which will typically be the form which is used by the service zone provisioning server 100 to define the service zone in step 272 of the service zone management protocol 250. Entry of the base address identifier 164 in step 268 of the service zone management protocol 250 by “clicking” the mouse 86 on the desired physical location of the geographical map which is being electronically presented on the display 74 may automatically affect execution of step 276. Conventional GIS software again may be utilized to provide this function.

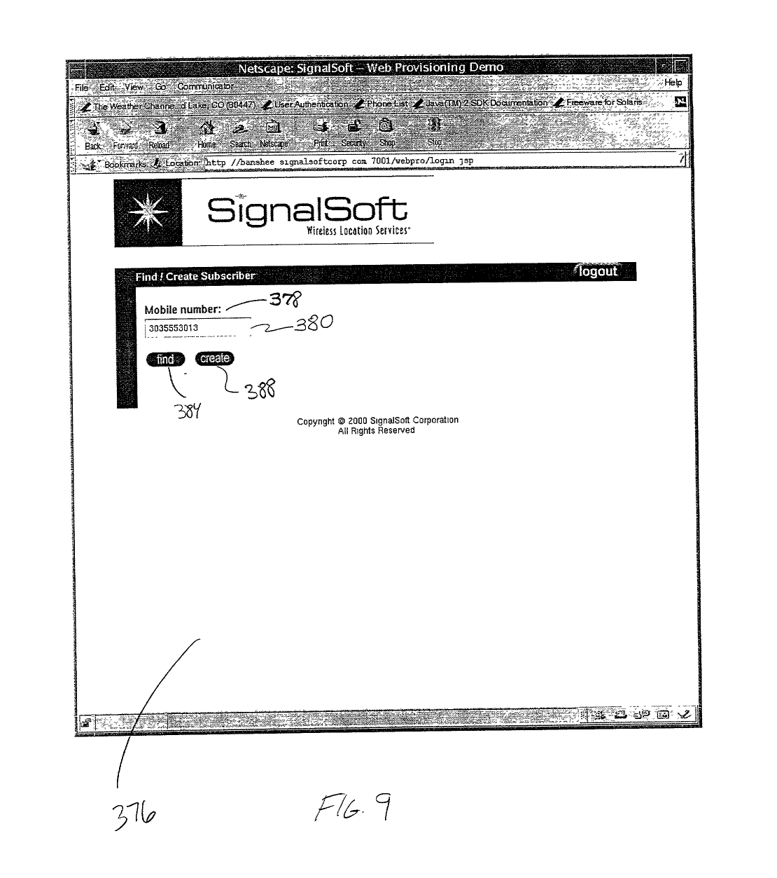

Once all of the relevant information has been provided to the service zone provisioning server 100, the service zone is generated through execution of step 280 of the service zone management protocol 250 of FIG. 7. This generation of the service zone may be automatically affected by the service zone provisioning server 100 upon receipt of all of the relevant data. All information which has been entered or otherwise selected is also preferably stored in the database system 112 of the service zone provisioning server 100, including the base address identifier 164 associated with step 268, the service zone information associated with step 272, and the result of the geocoding of the base address identifier 164 and which would be in the form of the geocoded base address identifier 172. The addition of a service zone for a particular mobile communications unit identifier 132 also preferably includes the electronic displaying of the same on an electronic geographical map of an area which includes the subject service zone. This is affected through step 288 of the service zone management protocol 250 of FIG. 7, and may be presented on the display 74 of the computer 66 being used by the user to access the service zone provisioning system 50. Further discussion of this aspect of the service zone management protocol 250 will be addressed in more detail below in relation to FIGS. 9-15, which present various screens which may be displayed to a user of the service zone provisioning system 50 on their respective display 74. Finally, step 290 of the protocol 250 provides for a return of control to a relevant portion of the service zone management protocol 250. It should be appreciated that certain changes in the ordering of thee steps for adding a service zone through the service zone management protocol 250 of FIG. 7 may be implemented without impacting the overall desired functionality of the protocol 250.

Another function which may be provided through the service zone management protocol 250 of FIG. 7 is the editing of one or more aspects of a service zone which has been previously defined in relation to a particular mobile communications unit identifier 132 and stored in the service subscriber database system 120. How this selection is made to affect this function again is not of particular significance. For instance, this option could be presented to the user of the service zone provisioning system 50 on the display 74 of the computer 66 being used to access the service zone provisioning server 100, and could be “selected” by “clicking” on this option with the mouse 86. In any case, step 292 “inquiries” as to whether the desired function is to edit one or more aspects of a particular service zone. “Responding” in the affirmative advances the service zone management protocol 250 from step 292 to a step 296. Step 296 is directed to the provision, entry, or identification of the service zone identifier 156 which is associated with the service zone to be edited, or so as to identify and retrieve the relevant record 124 from the service subscriber database system 120 for editing.

Information on the subject service zone may be electronically presented to the user on the display 74 of the user's computer 66 through execution of a step 300 of the service zone management protocol 250, including those aspects of the record 124 from the service subscriber database system 120 which are available for editing by the current user. Different degrees of access for editing may exist between the service provider and the service subscribers. That is, certain aspects of a given database record 124 from the service subscriber database system 120 may only be available for editing by or on behalf of the service provider, and not the subject service subscriber, or vice versa. Editing of information from one or more of the fields of the relevant database record 124 may be affected through execution of a step 304 of the protocol 250 (e.g., via the keyboard 82 of the computer), and thereafter may be stored in the service subscriber database system 120 by execution of a step 308. Fields of the service subscriber database system 120 which may be available for editing could include the base address field 160, the geocoded base address field 168, and the service zone radius field 176. It may be desirable to thereafter electronically display the “edited” service zone, along with other relevant information, on an electronic geographical map of an area which includes this service zone through execution of a step 312. Step 314 of the protocol 250 provides for a return of control to a relevant portion of the service zone management protocol 250.

Yet another function which may be provided through the service zone management protocol 250 of FIG. 7 is the deletion of a service zone which has been previously defined in relation to a particular mobile communications unit identifier 132. How the selection is made to affect this function again is not of particular significance. For instance, this option could be presented to the user of the service zone provisioning system 50 on the display 74 of the computer 66 being used by the user to access the service zone provisioning server 100, and could be “selected” by “clicking” on this option with the mouse 86. In any case, step 316 of the protocol 250 “inquiries” as to whether the desired function is to delete one or more service zones for the mobile communications unit identifier 132 that was previously provided at step 252 of the protocol 250. “Responding” in the affirmative advances the service zone management protocol 250 from step 316 to a step 320. Step 320 is directed to the entry or identification of the service zone identifier 156 which is associated with the service zone to be deleted, or so as to identify the relevant record 124 in the service subscriber database system 120 that is to be deleted. Once this information is provided to the service zone provisioning system 50, the relevant record 124 is deleted from the service subscribe database system 120 through execution of step 324 and would be recorded or reflected in the service subscriber database system 120. Step 328 of the protocol 250 provides for a return of control to a relevant portion of the service zone management protocol 250.

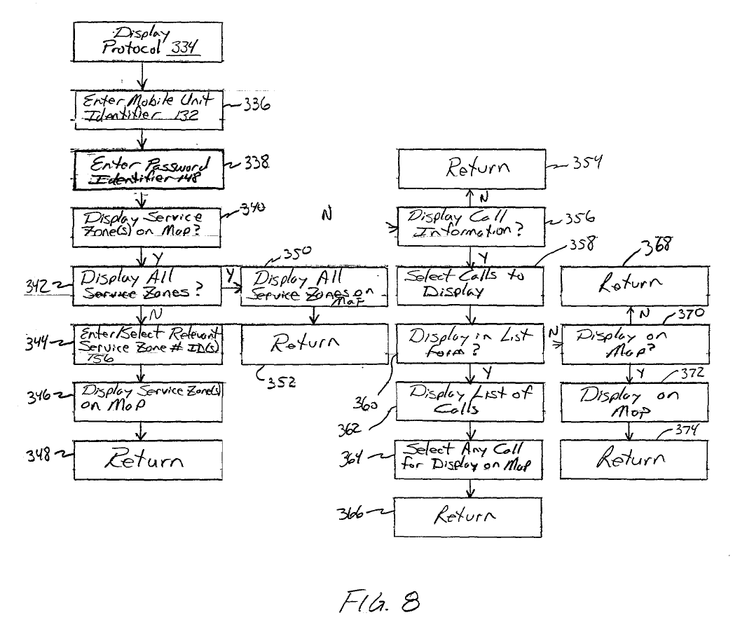

The service zone provisioning module 240 provides service zone management capabilities through the service zone management module 244 of FIG. 4 as just described. What may be characterized as more of an informational function may also be provided through the service zone provisioning module 240 of FIG. 4 as well. In this regard, the service zone provisioning module 240 further includes a display module 248. One protocol which may be employed by the display module 248 of FIG. 4 to provide this informational function is presented in FIG. 8. As noted above, the configuration of the computer 66 presented in FIG. 3 is an applicable configuration for any service provider computer 54 of the service zone provisioning system 50 or any service subscriber computer 58 of the service zone provisioning system 50. The display protocol of FIG. 8 will be discussed in relation to using the computer 66 for accessing and interfacing with the service zone provisioning server 100 as well.

The display protocol 334 of FIG. 8 is initiated by a step 336 where the mobile communications unit identifier 132 is somehow entered or otherwise selected (e.g., via the keyboard 82 of the computer 66 of FIG. 3, by using the mouse 82 to “click” on the associated mobile unit identifier 132 from a listing of mobile unit identifiers 132 being electronically presented on the display 74 of the computer 66). Security measures may be incorporated in relation to the service zone provisioning system 50 for execution of the display protocol 334 as well. In this regard, the protocol 250 includes a step 338 which is directed toward prompting the user of the service zone provisioning system 50 to enter the password identifier 148 which are associated with the mobile unit identifier 132 that was entered in step 336 of the protocol 334. Typically step 338 will only be presented/executed when access to the service zone provisioning server 100 is being attempted by a service subscriber via a service subscriber computer 58, versus by or on behalf of the service provider via a service provider computer 54 (FIG. 2). Nonetheless, the same or similar types of security measures could also be implemented when access to the service zone provisioning system 50 is being attempted by or on behalf of the service provider through a service provider computer 54.

Information may be electronically displayed to any single user of the service zone provisioning system 50 in the general manner provided by the display protocol 334, or may be simultaneously displayed to one or more users of the service zone provisioning system 50 in the general manner provided by the display protocol 334. Simultaneously displayed information will typically be to a particular subscriber and the service provider or a representative acting on behalf of the service provider (e.g., when discussing a particular call). Various types of information may be displayed through execution of the display protocol 334 of FIG. 8 and in various formats. How the selection is made to affect this function again is not of particular significance. For instance, an option to review service zone information could be presented to the user of the service zone provisioning system 50 on the display 74 of the computer 66 being used by the user to access the service zone provisioning server 100, and could be “selected” by “clicking” on this option with the mouse 86. In any case, step 340 “inquiries” as to whether the desired function is to display one or more service zones on a geographical map. “Responding” in the affirmative advances the display protocol 334 from step 340 to a step 342.

Virtually any way of displaying the service zones associated with a particular mobile communications unit identifier 132 may be implemented through the display protocol 334. All of the service zones which are associated with a given mobile unit identifier 132 (entered at step 336 of the protocol 334) may be electronically displayed on an electronic geographical map of an area which includes each of these service zones through execution of steps 342 and 350 of the protocol 334. Certain service zones which are associated with the mobile unit identifier 132 entered at step 336 of the protocol 334 may be electronically displayed on an electronic geographical map of an area which includes each of these service zones through execution of steps 342, 344, and 346 of the display protocol 334. The depiction of the service zone(s) on a geographical map of the relevant area is executed on the display 74 of the computer 66 being used to access the service zone provisioning server 100.

Selection of the service zone(s) to be displayed through the display protocol 334 may provide for the retrieval of the relevant geographical map(s) from the geographical maps database system 116 of FIG. 4, or again more typically the data used to generate any such map. Alternatively, an electronic map of a relevant geographical area may be presented to the user on the display 74, and the user may be allowed to “select” an area thereof to display all service zones which correspond with the subject mobile unit identifier 132 therein. Various “navigational” features also may be utilized in relation to the display protocol 334 as well in relation to the display of service zones, for instance to allow the user to “zoom in,” “zoom out,” or “pan.” Multiple degrees of detail may be provided on the relevant electronic map(s) which is being displayed. For instance, electronic maps of larger geographical areas that are being displayed (e.g., so as to display all service zones associated with a given mobile unit identifier 132) may provide less detail than those electronic maps of smaller geographical areas (e.g., to display one or more “spatially closer” service zones). In any case, steps 348 and 352 of the display protocol 334 each provide for a return of control to a relevant portion of the display protocol 334.

Another type of information which may be displayed to a user of the service zone provisioning system 50 through step 356 of the display protocol 334 of FIG. 8 relates to calls or communications which were previously made in relation to the mobile unit identifier 132 provided at step 336 of the protocol 334. Selection of those calls from the logged calls database system 184 of FIG. 4 which are desired to be displayed in some manner is affected through execution of step 358 of the protocol 334 of FIG. 8. Any way of affecting this selection may be implemented for purposes of the protocol 334, including based upon date and/or time. Any number of formats may be utilized in relation to the display of this logged call information as well. At least certain information regarding “selected” calls from the logged calls database system 184 which are associated with the mobile unit identifier 132 provided in step 336 may be displayed in list form through execution of steps 360 and 362 of the display protocol 334. Step 364 of the protocol 334 further provides that any one of these particular calls from the displayed list may thereafter be “selected” in an appropriate manner (e.g., by using the mouse 86 to “click” on the desired call from the list) so as to electronically display, on an electronic geographical map of the relevant area, the physical location of the mobile communications unit 14 at least at some point in time during the selected call. Relevant service zone information for the associated mobile unit identifier 132 may also be electronically displayed at this time as well. This same type of display of selected calls may be affected through execution of steps 370 and 372 of the display protocol 334 as well, and which does not require initially presenting the logged calls in list form. In any case, steps 366, 354, 368, and 374 of the display protocol 334 each provide for a return of control to a relevant portion of the display protocol 334 after execution of the associated function(s).

The functionality of the service zone provisioning system 50 is further addressed in relation to FIGS. 9-15 which present various “screens” which may be electronically presented to a user of the system 50. The service zone provisioning system 50 will continue to be addressed in relation to accessing the service zone provisioning server 100 of FIGS. 2 and 4 through the computer 66 of FIG. 3, which again is an appropriate configuration for any of the service provider computers 54 and any of the service subscriber computers 58 presented in the service zone provisioning system 50 of FIG. 2. FIG. 9 presents a find/create subscriber screen 376 which may be presented to a user of the service zone provisioning system 50 on the display 74 of the user's computer 66. The find/create subscriber screen 376 includes a mobile number prompt 378 and corresponding data entry area 380. A particular mobile unit identifier 132, typically associated with a particular mobile communications unit 14, may be entered in the data entry area 380 via the keyboard 82 of the user's computer 66. Existing subscribers would then activate the find button 384 (e.g., via a “click” of the mouse 86) to allow the service zone provisioning system 50 to verify the existence within the database system 112 of the mobile unit identifier 132 which was entered in the data entry area 380. New subscribers would instead activate the create button 388 in the same general manner to allow the service zone provisioning system 50 to input the mobile unit identifier 132 to the service subscriber database system 120. Other information regarding the new subscriber may be entered at this time as well, and thereafter stored at the relevant location within the database system 112.

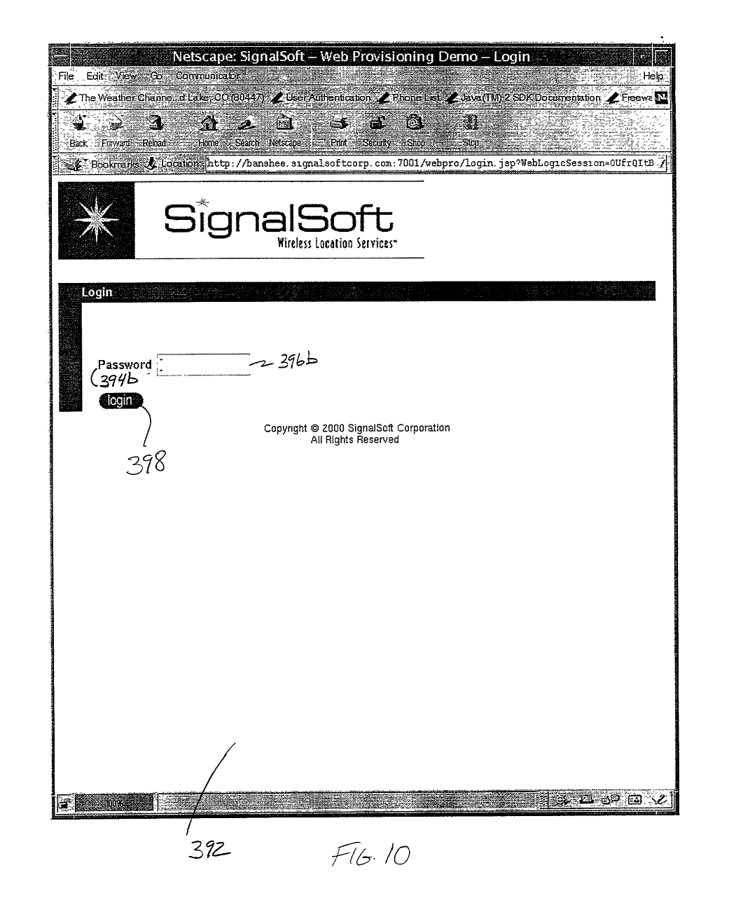

FIG. 10 presents one embodiment of a login screen 392 which may be presented to a user of the service zone provisioning system 50 on the display 74 of the user's computer 66 after the entry of the mobile unit identifier 132 at the find/create subscriber screen 376 of FIG. 9. The login screen 392 of FIG. 10 presents a password prompt 394b and corresponding data entry area 396b, typically for purposes of providing secured access to the service zone provisioning system 50 in relation to a particular mobile unit identifier 132. The password identifier 148 may be entered in the data entry area 396b via the keyboard 82 of the user's computer 66. Multiple entries of this information may be required in the case of a new subscriber for confirmation purposes. In any case, the desired functionality of the service zone provisioning system 50 for the particular mobile unit identifier 132 may then be accessed via “clicking” the login button 398 with the mouse 86 of the user's computer 66 or otherwise “selecting” this button 398. This would include accessing the service zone management protocol 250 of FIG. 7 and/or accessing the display protocol 334 of FIG. 8 as desired/required.

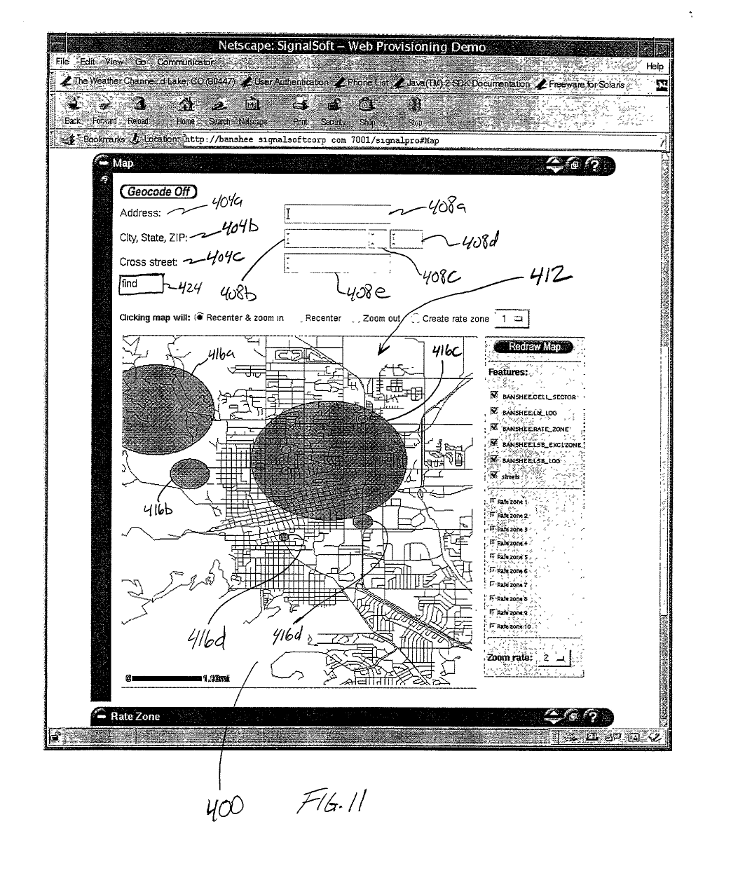

Service zone zones may be established for a particular mobile communications unit identifier 132 through a service zone generation screen 400 that is presented in FIG. 11 (e.g., via steps 260-290 of the service zone management protocol 250 of FIG. 7). The service zone generation screen 400 presents an address prompt 404a and corresponding data entry area 408a, a city, state, zip prompt 404b and corresponding data entry areas 408b-d, and a cross street prompt 404c and a corresponding data entry area 408e. The base address identifier 164 which is to be utilized in relation to the generation of a new service zone for the subject mobile communications unit identifier 132 may be entered in the data entry areas 408a-d via the keyboard 82 of the user's computer 66. Information entered in the data entry area 408e via the keyboard 82 of the user's computer 66 may be utilized to enhance the accuracy of locating the particular location which corresponds with the base address identifier 164. The actual location of the physical location which the service zone provisioning server 100 determined to correspond with the data provided in data entry areas 408a-e may be displayed on an electronic map 412 of the relevant geographical area. In any case, this information is stored in the service subscriber database system 120, and the service zone is generated based upon this information, by activation of the find button 424. This may also be utilized to electronically display the resulting service zone 416 on the electronic geographical map 412 which is presented on the service zone generation screen 400. Multiple service zones 416 are displayed on the geographical map 412 in FIG. 10. The electronic geographical map 412 preferably shows street and highways, as well as other types of information commonly displayed on maps (e.g., landmark locations, lakes, rivers, parks, golf courses).

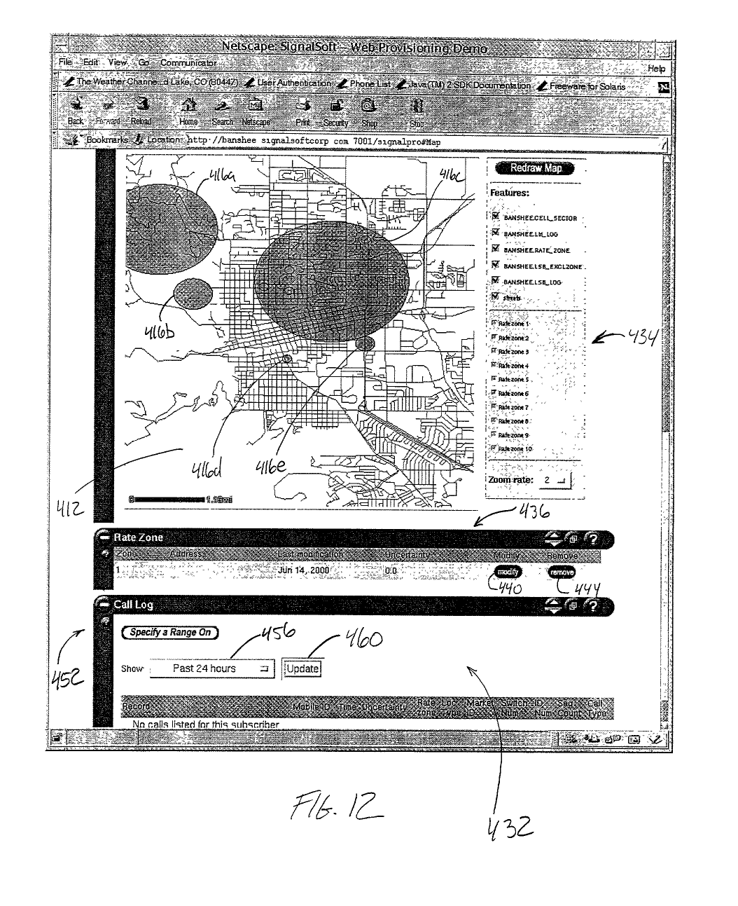

Call or communication information is addressed in relation FIGS. 12-14. The map/rate zone/call log screen 432 of FIG. 12 displays the electronic geographical map 412 and its various service zones 416 on a map display area 434 of the screen 432. A rate zone display area 436 is also included on the screen 432 for purposes of displaying service zone information regarding the particular mobile unit identifier 132 which was provided at the find/create subscriber screen of FIG. 9. This may include a listing of all of the service zones which have been thus far defined in relation to this particular mobile unit identifier 132 and which are stored in the service subscriber database system 120. A modify button 440 may be activated to execute an edit in relation to a service zone 416 which is listed in the rate zone display area 436 (e.g., via steps 292-314 of the service zone management protocol 250 of FIG. 7). A remove button 444 on the screen 432 may be activated to delete a service zone 416 which is listed in the rate zone display area 436 (e.g., via steps 316-332 of the service zone management protocol 250 of FIG. 7).

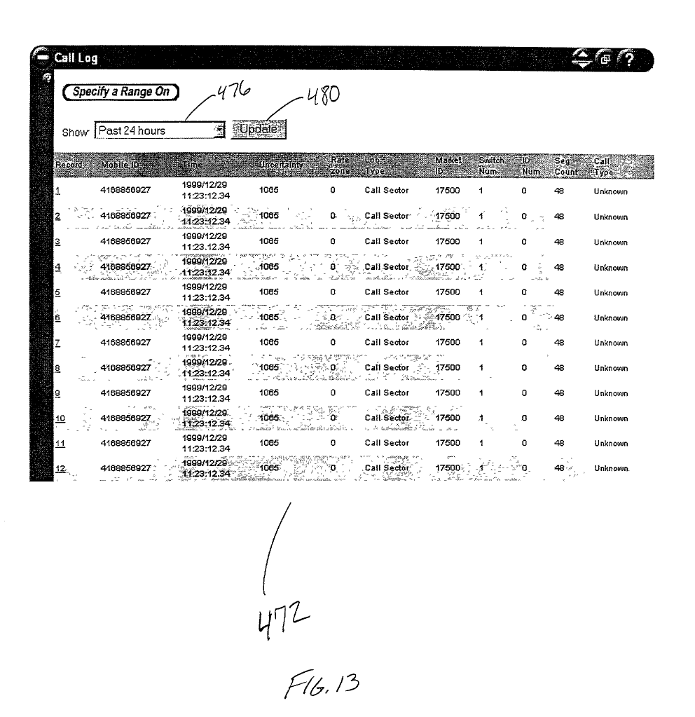

Information regarding calls utilizing a particular mobile communications unit identifier 132 is provided on a call log display area 452 of the screen 432 of FIG. 12. Calls which were previously made by a particular mobile unit identifier 132 which was entered at the find/create subscriber screen 376 of FIG. 9, which were logged by the location sensitive billing system 38 of FIG. 1, and which have been stored in the logged calls database system 184 of FIG. 4 in relation to this mobile unit identifier 132, may be displayed in various manners in the call log display area 452 of the screen 432 (e.g., via steps 356-374 of the display protocol 334 of FIG. 8). A call selection area 456 (e.g., a drop-down menu) is presented in the call log display area 452 to allow the user to somehow select those calls which are desired for display in the call log display area 452 by activation of the update button 460. This same information may also be displayed in the form presented on the call log screen 472 of FIG. 13 and in the same general manner using the call selection area 476 and update button 480.

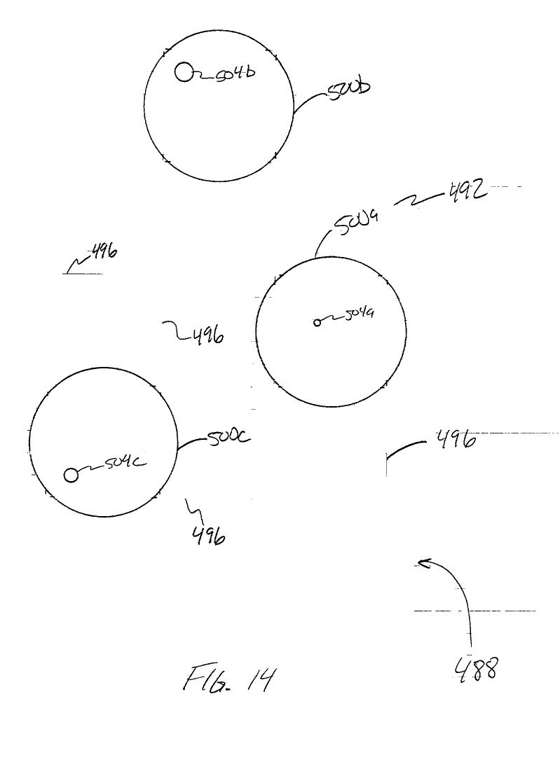

FIG. 14 presents a call display screen 488. The call display screen 488 displays an electronic geographical map 492 having a number of streets 496, and which may include other information (not shown) which is typically provided on conventional maps. A plurality of service zones 500 are displayed on the call display screen 488 in their relevant geographical location. A number of call locations 504 are also displayed on the call display screen 488. These call locations 504 each correspond with a physical location of the subject mobile communications unit 14 at least at some point in time when the unit 14 was involved in a particular communication. Notably, the size of the call location 504 is based upon the uncertainty identifier 220 associated therewith. Generally, the size of the call location 504 increases along with an increase in the magnitude of its associated uncertainty identifier 220, and decreases along with a decrease in the magnitude of its associated uncertainty identifier 220.

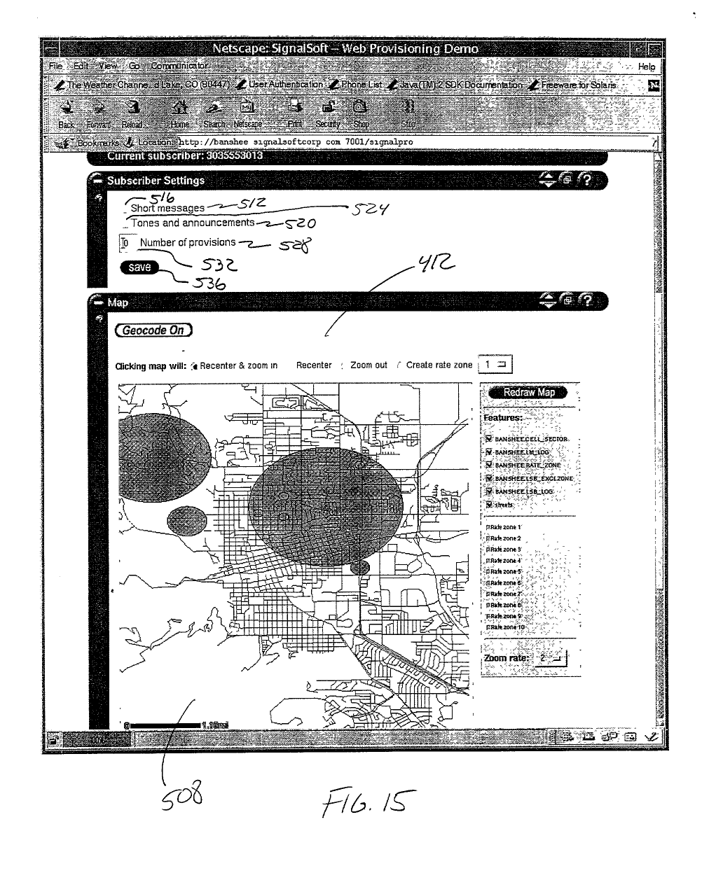

As noted above, various other types of information may be stored in relation to the service subscriber database system 120. FIG. 15 presents a subscriber settings screen 508 which may be electronically depicted on the display 74 of the user's computer 66 for these purposes. The screen 508 presents a short messages prompt 512 and a corresponding data entry area 516. Entering an appropriate selection indicator in the data entry area 516 will result in a user of the associated mobile communications unit 14 receiving textual messages on the unit 14 regarding billing or rate information for a particular call (e.g., before, during, after the call). The screen 508 also includes a tones and announcements prompt 520 and a corresponding data entry area 524. Entering an appropriate selection indicator in the data entry area 524 will result in a user of the associated mobile communications unit 14 receiving an audible indication on the unit 14 regarding billing or rate information for a particular call (e.g., before, during, after the call). Finally, the screen 508 provides a number of provisions prompt 528 and a corresponding data entry area 532. Entry of a number in the data entry area 532 sets the number of service zones which may be established in relation to the subject mobile unit identifier 132. Information which is entered via the screen 508 may be saved to the appropriate location within the database system 112 by activation of the button 536.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A method for defining a zone, comprising the steps of:
identifying a first physical location,
defining a first zone based upon said identifying step; and
electronically displaying said first zone on a first map of a first geographical area.

2. A method, as claimed in claim 1, wherein:
said identifying step comprises a entering a first address which corresponds with said first physical location, and thereafter geocoding said first address into first geo-referenced data.

3. A method, as claimed in claim 1, wherein:
said identifying step comprises electronically displaying a second map of a second geographical area on a first display of a first computer system, and thereafter selecting said first physical location on said second map with a first data entry device of said first computer system.

4. A method, as claimed in claim 3, wherein:
said first computer system comprises a mouse, and wherein said selecting step comprises clicking on said first physical location on said second map with said mouse.

5. A method, as claimed in claim 3, wherein:
said selecting step comprises touching said first physical location on said second map on said first display.

6. A method, as claimed in claim 1, further comprising the step(s) of:
geocoding information which identifies said first physical location after said identifying step.

7. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said identifying step comprises establishing communication between a first server and a first computer, entering said first mobile communications number through said first computer, directing data representative of said first physical location from said first computer toward said first server, entering security information which is associated with said first mobile communications number through said first computer, and directing data which is representative of said security information from said first computer toward said first server, wherein each of said entering said first mobile communications number step, said entering security information step, and said identifying a first physical location step are executed by or on behalf of a party which is assigned said first mobile communications number by a service provider of said first mobile communications service.

8. A method, as claimed claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said identifying step comprises establishing communication between a first server and a first computer, entering said first mobile communications number through said first computer, and directing data representative of said first physical location from said first computer toward said first server, wherein said entering said first mobile communications number and said identifying a first physical location step are executed by or on behalf of a service provider of said first mobile communications service.

9. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said identifying step is executed by or on behalf of a party which was assigned said first mobile communications number by a technique which is selected from the group consisting of entering data which is representative of said first physical location, selecting said first physical location on an electronic map, and any combination thereof.

10. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said identifying a first physical location step is executed at a time when said first mobile communications number is initially assigned.

11. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said identifying a first physical location step is executed at some point in time after said first mobile communications number has already been assigned.

12. A method, as claimed in claim 1, wherein:
said defining step comprises using said first physical location as a center of a circle which defines a perimeter of said first zone.

13. A method, as claimed in claim 1, wherein:
said defining step is automatically executed by a first server in accordance with a first protocol, which in turn uses data corresponding with said first physical location.

14. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said first service zone is selected from the group consisting of a home service zone and a business service zone.

15. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said electronically displaying step is executed on a first display device of a party which has been assigned said first mobile communications number.

16. A method, as claimed in claim 1, wherein:
said first zone is a first service zone for a first mobile communications number of a first mobile communications unit which utilizes a first mobile communications service, wherein all communications involving said first mobile communications number from within said first service zone are billed at a first rate, and wherein:
said electronically displaying step is executed on a first display device associated with a service provider of said first mobile communications service.

17. A method, as claimed in claim 1, wherein:
said electronically displaying step comprises electronically displaying a boundary of said first zone.

18. A method, as claimed in claim 1, wherein:
said electronically displaying step comprises electronically displaying said first zone in a first color and electronically displaying a portion of said first map disposed about said first zone in a second color which is different from said first color.

19. A method, as claimed in claim 1, wherein:
said electronically displaying step comprises electronically displaying said first zone in a first shade and electronically displaying a portion of said first map disposed about said first zone in a second shade which is different from said first shade.

20. A method, as claimed in claim 1, wherein:
said electronically displaying step comprises displaying on said first map streets and highways within said first geographical area.

21. A method, as claimed in claim 1, wherein:
said electronically displaying step comprises displaying on said first map landmark information located within said first geographical area.

22. A method, as claimed in claim 1, further comprising the step(s) of:
identifying a second physical location;
defining a second zone based upon said second physical location; and
electronically displaying said second zone on a second map of a second geographical area simultaneously with said first zone.

23. A method, as claimed in claim 22, wherein:
said second geographical area is larger than said first geographical area.

24. A method, as claimed in claim 22, wherein:
said second map provides less detail than said first map.

25. A method, as claimed in claim 22, wherein:
said first and second geographical areas are the same.

26. A method, as claimed in claim 22, wherein said first zone is a first service zone and wherein said second zone is a second service zone for a first mobile communications number of a first mobile communications unit which utilizes a first mobile communications service, wherein all communications involving said first mobile communications number from within said first service zone are billed at a first rate, wherein all communications involving said first mobile communications number from within said second service zone are billed at a second rate which is different from said first rate, and wherein said method further comprises the step(s) of:
storing data representative of said first service zone on a computer-readable storage medium in association with said first mobile communications number;
storing data representative of said second service zone on said computer-readable storage medium in association with said first mobile communications number; and
storing data represented of said first map on said computer-readable storage medium.

27. A method, as claimed in claim 22, further comprising the step(s) of:
identifying a third physical location;
defining a third zone based upon said third physical location; and
electronically displaying said third zone on a third map of a third geographical area simultaneously with said first and second service zones.

28. A method, as claimed in claim 27, wherein:
said third geographical area is larger than at least one of said first and second geographical areas.

29. A method, as claimed in claim 27, wherein:
said third map provides less detail than said map which corresponds with said at least one of said first and second geographical areas.

30. A method, as claimed in claim 27, wherein:
said first, second, and third geographical areas are the same.

31. A method, as claimed in claim 27, wherein said first zone is a first service zone, said second zone is a second service zone, and said third zone is a third service zone for a first mobile communications number of a first mobile communications unit which utilizes a first mobile communications service, wherein all communications involving said first mobile communications number from within said first service zone are billed at a first rate, wherein all communications involving said first mobile communications number from within said second service zone are billed at a second rate which is different from said first rate, wherein all communications involving said first mobile communications number from within said third service zone are billed at a third rate which is different from said first and second rates, and wherein said method further comprises the step(s) of:
storing data representative of said first service zone on a computer-readable storage medium in association with said first mobile telecommunications number;
storing data representative of said second service zone on said computer-readable storage medium in association with said first mobile telecommunications number;
storing data representative of said third service zone on said computer-readable storage medium in association with said first mobile telecommunications number; and
storing data representative of said first, second, and third maps on said computer-readable storage medium.

32. A method, as claimed in claim 1, further comprising the step(s) of:
deleting said first zone;
identifying a new first physical location after said the deleting step;
defining a new first zone based upon said new first physical location; and
electronically displaying said new first zone on said first map of said first geographical area.

33. A method, as claimed in claim 1, further comprising the step(s) of:
accessing a first Web site on a first server;
sending a request for data representative of said first physical location from said first server to a first computer which is remotely located in relation to and operatively interconnected with said first server, wherein said selecting step is executed through said first computer and generates first data;
sending said first data from said first computer to said first server, wherein said first server executes said defining step after said sending said first data step, wherein second data is representative of said first zone; and
sending said second data from said first server to said first computer, wherein said displaying step is executed on said first computer from said second data.

34. A method, as claimed in claim 1, further comprising the step(s) of:
storing data representative of said first service zone on a computer-readable storage medium; and
storing data representative of said first map on said computer-readable storage medium.

35. A method for providing service zone information on a first mobile communications number for a first mobile communications unit which utilizes a first mobile telecommunications service, said method comprising the steps of:
electronically displaying a first service zone on a first map of a first geographical area, wherein all communications involving said first mobile communications number from within said first service zone are billed at a first rate; and
electronically displaying a first physical location of said first mobile telecommunications unit at a time when said first mobile telecommunications unit was used for a first communication with another communications device, wherein said electronically displaying a first physical location step is executed on said first map.

36. A method, as claimed in claim 35, wherein:
both of said electronically displaying steps are executed on a first display device associated with a service provider of said first mobile communications service.

37. A method, as claimed in claim 35, wherein:
both of said electronically displaying steps are executed on a first display device of a party which as been assigned said first mobile communications number.

38. A method, as claimed in claim 35, wherein:
said first physical location encompasses a second geographical area which is smaller than said first service zone but which is larger than a single longitude/latitude coordinate, wherein said second geographical area accounts for an uncertainty as to an exact position of said first mobile communications unit when said first communication was made.

39. A method, as claimed in claim 35, wherein:
said electronically displaying a first physical location step further comprises displaying, on said first map, streets and highways which are located within said first geographical area.

40. A method, as claimed in claim 35, wherein:
said electronically displaying a first physical location step comprises displaying, on said first map, landmark information which is located within said first geographical area.

41. A method, as claimed in claim 35, further comprising the step(s) of:
electronically displaying a second geographical area which encompasses a plurality of service zones which are currently in effect for said first mobile communications number, wherein said electronically displaying a second geographical area is executed on a second map, and wherein said electronically displaying a second geographical area step is based upon said providing step.

42. A method, as claimed in claim 41, wherein:
said second geographical area is larger than said first geographical area, and wherein said first geographical area is entirely contained within said second geographical area.

43. A method, as claimed in claim 41, wherein:
said second map provides less detail than said first map.

44. A method, as claimed in claim 41, further comprising the step(s) of:
providing an option to display said second map without displaying any physical location information, wherein said physical location information identifies a physical location of said first mobile communications unit when said first mobile telecommunications unit was previously used for making a communication within an area encompassed by said second map.

45. A method, as claimed in claim 41, further comprising the step(s)to of:
providing an option to display said second map with physical location information, wherein said physical location information identifies a physical location of said first mobile communications unit when said first mobile communications unit was previously used for making a communication within an area encompassed by said second map.

46. A method, as claimed in claim 41, further comprising the step(s) of:
providing criteria for selecting communications involving said first mobile communications number where it is desired to electronically display on said second map said physical location of said first mobile telecommunications unit when used for a communication within an area encompassed by said second map;
electronically displaying on said second map physical location information of said first mobile communications unit for each said communication which satisfies said criteria from said providing step.

47. A method, as claimed in claim 41, further comprising the step(s) of:
selecting said first service zone on said second map, and executing both of said electronically displaying steps based upon said selecting step.

48. A method, as claimed in claim 35, further comprising the step(s) of:
displaying a list of communications involving said first mobile communications number, wherein said first communication is on said list of communications; and
selecting said first communication from said list of communication.

49. A method, as claimed in claim 48, wherein:
both of said electronically displaying steps are executed in response to said selecting step.

50. A method, as claimed in claim 48, wherein:
both of said electronically displaying steps are executed after said selecting step.

51. A method, as claimed in claim 35, further comprising the step(s) of:
providing access to a first Web site on a first server through a first computer which is remotely located in relation to and operatively interconnected with said first server;
directing a request for service zone information toward said first server;
directing data which represents said first service zone and said first map toward said first computer, wherein said directing data which represents said first service zone step is executed in response to said directing a request for service zone information step, and wherein said electronically displaying a first service zone step is executed after said directing a request for service zone information step;
directing a request for first communication information toward said first server; and
directing data which defines said first physical location toward said first computer, wherein said directing data which defines said first physical location step is executed in response to said directing a request for first communication information step, and wherein said electronically displaying a first physical location step is executed after said sending a request for first communication information step.

52. A method, as claimed claim 35, further comprising the step(s) of:
establishing communication between a first server and a first computer;
entering identifying information regarding said first mobile telecommunications service account through said first computer;
directing data representative of said identifying information from said first computer toward said first server;
entering security information regarding said first mobile telecommunications service account through said first computer; and
directing data representative of said security information from said first computer toward said first server, wherein each of said entering identifying information step, said entering security information step, said electronically displaying a first service zone step, and said electronically displaying a first physical location step are executed by a party which has been assigned said first mobile communications number.

53. A method, as claimed claim 35, further comprising the step(s) of:
establishing communication between a first server and a first computer;
entering identifying information regarding said first mobile telecommunications service account through said first computer;
directing data representative of said identifying information from said first computer toward said first server, wherein said entering identifying information step, said electronically displaying a first service zone step, and said electronically displaying a first physical location step are executed on behalf of a service provider of said first mobile communications service.
